(19) United States
(12) Patent Application Publication
(10) Pub. No.: US 2018/0123281 A1
(43) Pub. Date: May 3, 2018

(54) PROTECTIVE CAP FOR AN ATTACHMENT HOUSING

(71) Applicant: HARTING Electric GmbH & Co. KG, Espelkamp (DE)

(72) Inventors: Sebastian Griepenstroh, Lübbecke (DE); Florian Schenk, Löhne (DE)

(21) Appl. No.: 15/567,526

(22) PCT Filed: Mar. 30, 2016
(86) PCT No.: PCT/DE2016/100150

§ 371 Date: Oct. 18, 2017

(30) Foreign Application Priority Data
May 5, 2015 (DE) 10 2015 106 963.6

(51) Int. Cl. H01R 13/52; H01R 13/506

(52) U.S. Cl. CPC H01R 13/5213; H01R 13/506

(57) ABSTRACT

The disclosure relates to a protective cap for an attachment housing. The protective cap has a basic shape which is substantially box-shaped. The protective cap has a first locking device on the narrow faces of the box-shaped basic shape, and the protective cap has a second locking device on at least one broad face of the box-shaped basic shape. The disclosure likewise relates to a system comprising such a protective cap and a matching attachment housing. Advantageously, the locking devices of the protective cap can be used with and without a locking bracket of an attachment housing.

### BACKGROUND

### Technical Field

This disclosure relates to a protective cap for an attachment housing and a system comprising a protective cap and a matching attachment housing.

Protective caps of this type are used to close attachment housings for plug connections of a machine or an appliance securely and tightly against media when no plug connector is plugged into the attachment housing.

### Description of the Related Art

DE 10 2010 061 384 A1 shows a protective cap for an attachment housing, wherein the protective cap has a locking pin on each of the narrow sides of the box-like basic shape, and wherein the protective cap has a locking magnet on at least one wide side of the box-like basic shape.

U.S. Pat. No. 7,915,528 B2 shows a protective cap for an attachment housing, wherein the protective cap a locking eye is integrally molded on at least one wide side of the box-like basic shape.

DE 691 14 560 T2 shows a socket securing cap which has two hinge receptacles on a wide side and, on at least one narrow side, a locking tongue which can be engaged in a locking lug on the socket.

DE 10 2013 004 551 A1, DE 10 2012 102 188 A1 and DE 24 51 662 A1 each show a protective cap for an attachment housing, wherein the protective caps each have a locking pin on the narrow sides of the box-like basic shape.

EP 1 830 430 3A3 shows an attachment housing for a plug connection. The protective cap is connected in an articulated manner to the attachment housing at two points. Via a pivoting movement, the protective cap can be folded onto the attachment housing and fixed thereto via a locking clip.

A locking mechanism of this type is complex and subject to wear. In addition, the protective cap is irreversibly connected to the attachment housing, which can cause space problems for the plug connector.

### BRIEF SUMMARY

Embodiments of the present invention provide a protective cap for an attachment housing which can be handled simply and produced inexpensively.

Embodiments of the present invention are directed to a protective cap that is provided for the media-tight sealing of an attachment housing of a plug connection. The protective cap has a substantially box-like basic shape. The attachment housing has first locking device on each of the narrow sides of the box-like basic shape. The protective cap comprises a second locking device on at least one wide side of the box-like basic shape. The first and second locking devices are different.

In an attachment housing there are generally contact elements which can make electrical contact with corresponding contact elements of a plug connector that can be plugged into or onto the attachment housing.

Advantageously, the first locking device comprises locking pins. A locking clip which can engage over the locking pins can be pivotably attached to the attachment housing. As a result, the protective cap is fixed on the attachment housing particularly securely and media-tightly.

In a particularly advantageous refinement, the two wide sides of the box-like basic shape have a locking device. Preferably, the two wide sides have different locking devices, wherein one wide side has the second locking device and the other wide side has a third device. In an advantageous refinement, the second locking device is a locking lug. Preferably, the third locking device is part of a hinge. The attachment housing has the other part of the hinge. The protective cap is accordingly connected to the attachment housing via a hinge connection. The attachment housing has a latching protrusion over which the locking lug of the protective cap can engage, by which fixing of the protective cap to the attachment housing is carried out in the closed state. By way of the second and third locking devices, the protective cap can be fixed to the attachment housing without a locking clip.

### BRIEF DESCRIPTION OF THE SEVERAL VIEWS OF THE DRAWINGS

An exemplary embodiment of the invention is illustrated in the drawings and will be explained in more detail below. In the drawings:

FIG. 1 shows a perspective illustration of a protective cap,

FIG. 2 shows a perspective illustration of a system comprising a protective cap and an attachment housing with locking clip,

FIG. 3 shows a further perspective illustration of the system comprising a protective cap and an attachment housing with locking clip,

FIG. 4 shows a further perspective illustration of the system comprising a protective cap and an attachment housing without locking clip,

FIG. 5 shows a lateral illustration of the system comprising a protective cap and an attachment housing with locking clip,

FIG. 6 shows a further lateral illustration of the system comprising a protective cap and an attachment housing with locking clip,

FIG. 7 shows a further lateral illustration of the system comprising a protective cap and an attachment housing with locking clip,

FIG. 8 shows a close-up of a locking pin and an active region of the locking clip, and

FIG. 9 shows a close-up of the locking pin.

The figures contain partially simplified schematic illustrations. To some extent, identical designations are used for the same but possibly not identical elements. Various views of the same elements could be scaled differently.

### DETAILED DESCRIPTION

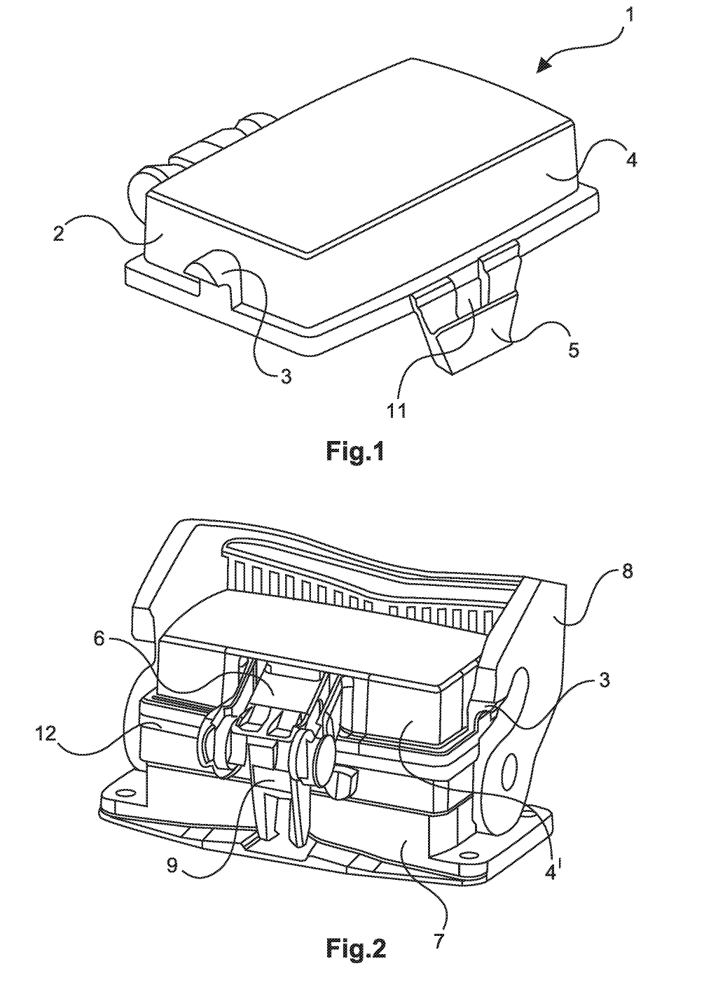

FIG. 1 shows a perspective illustration of a protective cap 1 according to an example embodiment of the invention. The protective cap 1 has a substantially box-like shape. Locking pins 3 are integrally molded on both narrow sides 2 of the protective cap 1. From one wide side 4, a locking lug 5 integrally molded thereon projects. Part of a hinge 6 is integrally molded on the opposite wide side 4′.

In FIGS. 2, 3 and 5-7, in each case a system comprising a protective cap 1 and an attachment housing 7 can be seen. In these embodiments, a locking clip 8 is pivotably fixed to the attachment housing 7 and, in interaction with the locking pins 3, fixes the protective cap 1 reversibly to the attachment housing 7. The attachment housing 7 has a second part of a hinge 9, which is either integrally molded on the attachment housing 7 or fixed thereto. As a result of the hinge connection, the protective cap 1 can be pivoted open and expose a plug-in area (not shown) within the attachment housing 7. Pivoting closed in order to close the attachment housing 7 is likewise possible.

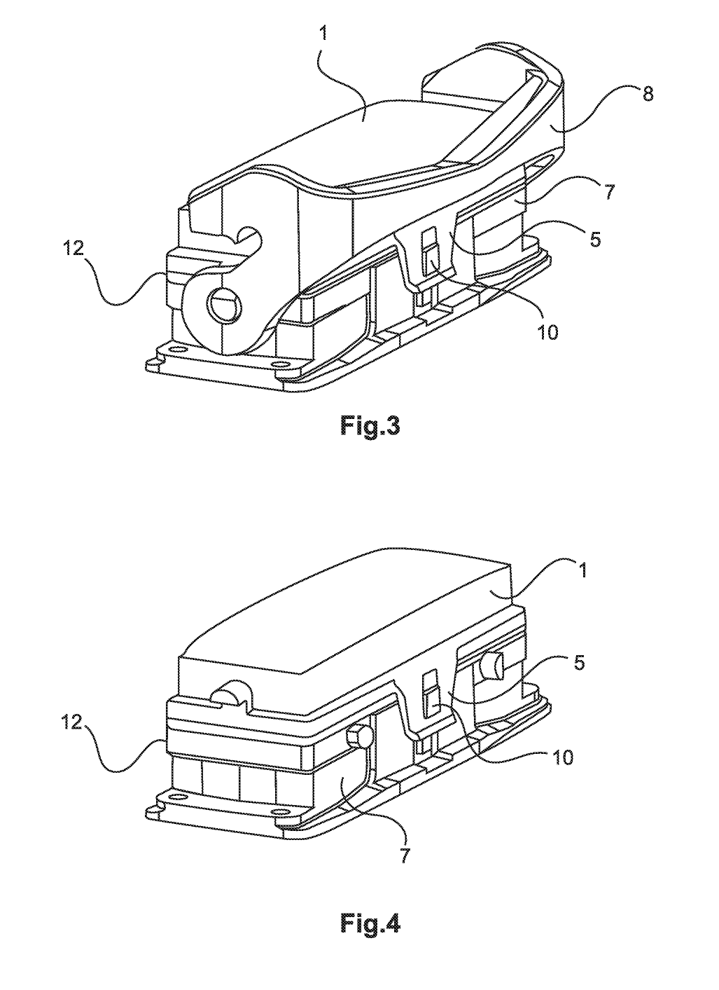

The locking lug 5 integrally molded on the protective cap 1 can be guided over a latching projection 10 integrally molded on the attachment housing 7, as shown, for example, in FIG. 3. In the process, the front beveled edge of the locking lug 5 initially slides over the latching projection 10. The locking lug 5 then snaps over the latching projection 10, so that the latter is then located in a cut-out 11 in the locking lug 5. The hinge 6, 9 and the locking lug 5 are sufficient to fix the protective cap 1 to the attachment housing 7 in a media-tight and reversible manner. A gasket 12 is provided between the protective cap 1 and the attachment housing 7.

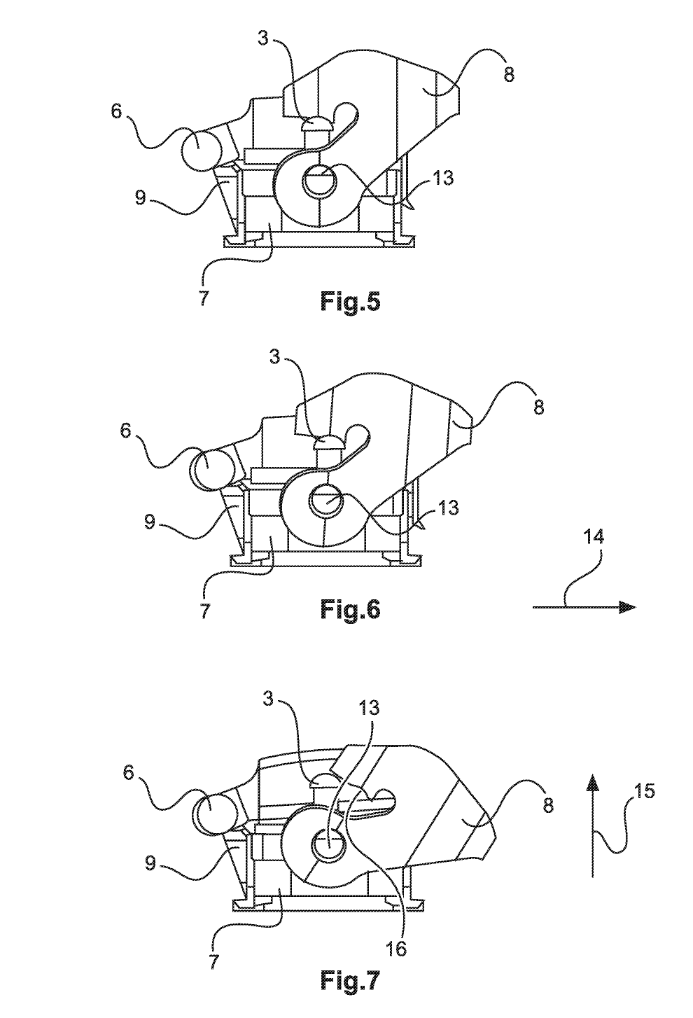

In FIGS. 5 to 7, the closure principle of the system comprising protective cap 1 and attachment housing 7 with a locking clip 8 is shown. The locking clip 8 is pivotably mounted via pins 13 integrally molded on the attachment housing 7.

In FIG. 5, the closed state of protective cap 1 and attachment housing 7 is shown. The locking pins 3 and an active region 16 of the locking clip 8 are shaped such that as the locking clip 8 is actuated in order to open the protective cap 1, the protective cap 1 is first moved in the direction of the arrow 14, as a result of which the locking lug 5 is guided over the latching projection 10

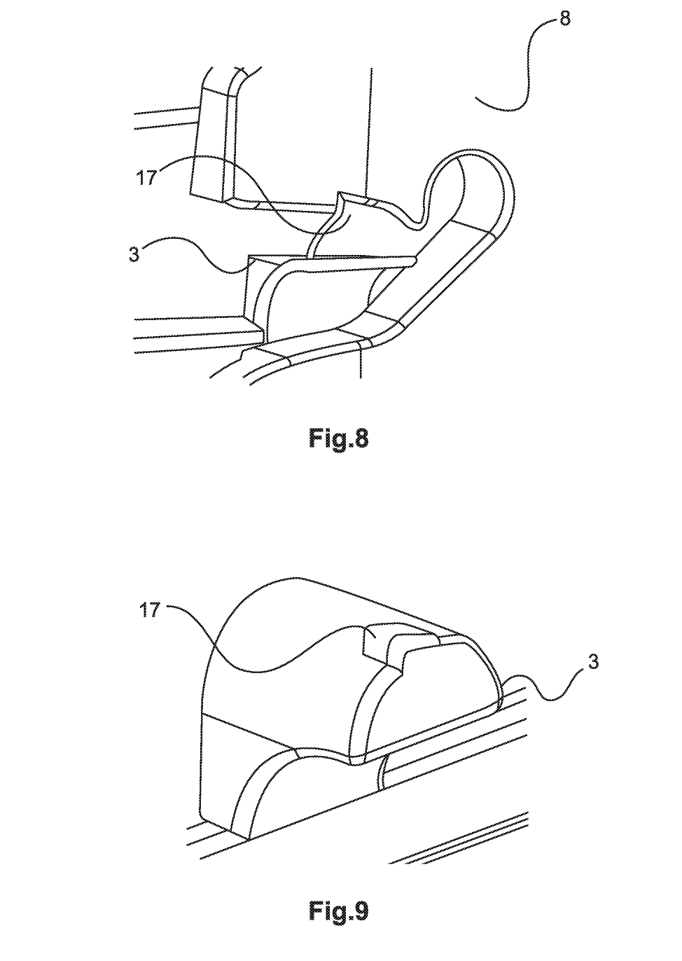

(FIG. 6). By way of an onward movement of the locking clip 8, the protective cap 1 is then moved in the direction of the arrow 15 and opened, as illustrated in FIG. 7. The protective cap 1 is unlocked and is forced upward by the sealing force as soon as the locking clip 8 has moved away from the locking pin 3.

An advantageous feature of the solution shown in the illustrated embodiments consists in the fact that the locking devices of the protective cap 1 can be used with and without locking clip 8 of an attachment housing 7.

The active region 16 of the locking clip 8 is formed by two end regions of the locking clip 8, which act on the respective locking pins 3. According to the illustrated embodiment, the active region 16 has an S shape in side view.

A particularly advantageous embodiment of the protective cap 1 is shown in FIGS. 8 and 9. An additional latching projection 17 is integrally molded on the locking pin 3. If the friction between the locking pin 3 and the active region 16 of the locking clip 8 is too low, the latching projection 17 ensures that the protective cap 1 is forced sufficiently in the opening direction thereby.

In general, in the following claims, the terms used should not be construed to limit the claims to the specific embodiments disclosed in the specification and the claims, but should be construed to include all possible embodiments along with the full scope of equivalents to which such claims are entitled.

1. A protective cap for an attachment housing, comprising:
a substantially box-like basic shape with narrow sides and wide sides;
a respective locking pin on each of the narrow sides of the box-like basic shape; and
a locking lug on at least one of the wide sides of the box-like basic shape.

2. The protective cap as claimed in claim 1, wherein a respective latching projection is integrally molded on each locking pin.

3. The protective cap as claimed in claim 1, wherein each of the wide sides of the box-like basic shape has a respective locking device.

4. The protective cap as claimed in claim 3, wherein the wide sides have different locking devices.

5. The protective cap as claimed in claim 4, wherein the locking device of one of the wide sides is part of a hinge and the locking device of the other one of the wide sides is the locking lug.

6. A system comprising a protective cap as claimed in claim 1 and an attachment housing.

7. The system as claimed in claim 6, wherein a locking clip is pivotably attached to the attachment housing.

8. The system as claimed in claim 6, wherein the protective cap comprises a first part of a hinge on one of the wide sides and a second part of the hinge is attached to or integrally molded on the attachment housing.
